(19) United States
(12) Patent Application Publication
(10) Pub. No.: US 2025/0299584 A1
(43) Pub. Date: Sep. 25, 2025

(54) CONTEXT AWARE NOTICES TO AIR MISSIONS AUTOMATION ALGORITHM

(71) Applicant: Rockwell Collins, Inc., Cedar Rapids, IA (US)

(72) Inventors: Niko Voutilainen, Cedar Rapids, IA (US); David Watkins, Syracuse, UT (US); Janet Liu, Broomfield, CO (US); David Young, Garden Ridge, TX (US); Michael Krenz, Roscoe, IL (US)

(21) Appl. No.: 18/615,270

(22) Filed: Mar. 25, 2024

(51) Int. Cl. G08G 5/00

(52) U.S. Cl. CPC G08G 5/21; G08G 5/20; G08G 5/32

(57) ABSTRACT

A system for filtering and presenting notifications received by an aircraft includes a processor, a display device, a communication device, and computer-readable memory. The computer-readable memory encoded with instructions that, when executed by the processor, cause the system to perform the following steps. The system receives one or more broadcast notifications. The notifications are, for example, Notices to Air Missions (NOTAMs). The system filters the one or more broadcasted notifications based upon applicability to a present flight plan to generate applicable notifications. The system filters the applicable notifications based upon one or more filtering criteria to assign a criticality to each of the applicable notifications. The system display, via the display device, the applicable notifications based upon the criticality of each of the applicable notifications. The system outputs alternate flight plans due to restrictions on the present flight plan.

### BACKGROUND

Aircraft pilots receive several Notices to Air Missions (NOTAMs) during the operation of an aircraft. NOTAMs contain various information regarding aspects of the departure airport, the flight path, and/or the destination airport. NOTAMs are of varying importance, with some being critical to the flight path of an aircraft and others being information that may be beneficial to know, but not altogether consequential. For example, a NOTAM can inform the pilot that a weather event is occurring within the expected flight path of the aircraft. A different NOTAM can inform the pilot that a lawn on the east side of the landing runway is being mowed. NOTAMs are currently presented as a list of standard abbreviations which the aircraft crew must review in order to find and determine if any NOTAMs are of critical importance. Thus, if the list of NOTAMs is lengthy (e.g., more than 50), there is significant potential for NOTAMs of critical importance to be missed by the aircraft crew. Hence a system for automatically sorting NOTAMs for criticality is desirable.

### SUMMARY

A system for filtering and presenting notifications received by an aircraft includes a processor and a display device operably connected to the processor. The system further includes a communication device operably connected to the processor. The system further includes computer-readable memory operably connected to the processor, the computer-readable memory encoded with instructions that, when executed by the processor, cause the system to perform the following steps. The system receives, via the communication device, one or more broadcasted notifications. The system filters the one or more broadcasted notifications based upon applicability to a present flight plan to generate one or more applicable notifications. The system filters the one or more applicable notifications based upon one or more filtering criteria to assign a criticality to each of the one or more applicable notifications. The system displays, via the display device, the one or more applicable notifications based upon the criticality of each of the one or more applicable notifications. The system outputs one or more alternate flight plans in response to at least one of the one or more applicable notifications restricting the present flight plan. The one or more alternate flight plans include any planned route to be taken by the aircraft including brake release, motion on the ground, air travel, and parking brake application at a destination.

A method for filtering and presenting notifications received by an aircraft includes receiving via a communication device, one or more broadcasted notifications. The method further includes filtering the one or more broadcasted notifications based upon applicability to a present flight plan to generate one or more applicable notifications. The method further includes filtering the one or more applicable notifications based upon one or more filtering criteria to assign a criticality to each of the one or more applicable notifications. The method further includes displaying, via a display device, the one or more applicable notifications based upon the criticality of each of the one or more applicable notifications.

### BRIEF DESCRIPTION OF THE DRAWINGS

FIG. 1 is a schematic view of a system for filtering and presenting one or more notifications.

FIG. 2A is an example pilot interface for displaying alternate flight plans based upon the one or more notifications.

FIG. 2B is an example pilot interface for displaying the one or more notifications as a map overlay.

FIG. 3 is a flowchart depicting a method for filtering and presenting notifications.

### DETAILED DESCRIPTION

The techniques of this disclosure relate to a system for parsing and presenting notifications, and specifically Notices to Air Missions (NOTAMs), to an aircraft crew. NOTAMs include notices regarding the status of components within the National Airspace System (NAS). Such notices are generally real-time notices and describe an abnormal status of the NAS such as the establishment, condition, or change of any facility, service, procedure, or hazard in the NAS. The system receives a plurality of NOTAMs from publishing authorities, parses the NOTAMs, and determines the applicability and criticality of the NOTAMs based upon filtering criteria and based upon the current flight plan. Based upon the applicability and criticality of the NOTAMs, the system notifies the aircraft crew of salient NOTAMs. If an alternate flight plan is required based upon one or more of the NOTAMs (e.g., flying through temporary flight restriction), the system can propose alternate flight plans. The system performs continuous monitoring such that new NOTAMs that may occur during flight are flagged as they are published. Additionally, the system can be triggered to flag relevant and critical NOTAMs for alternate proposed flight plans. The techniques of this disclosure allow for timely notification of salient NOTAMs such that critical information does not go unseen by the flight crew.

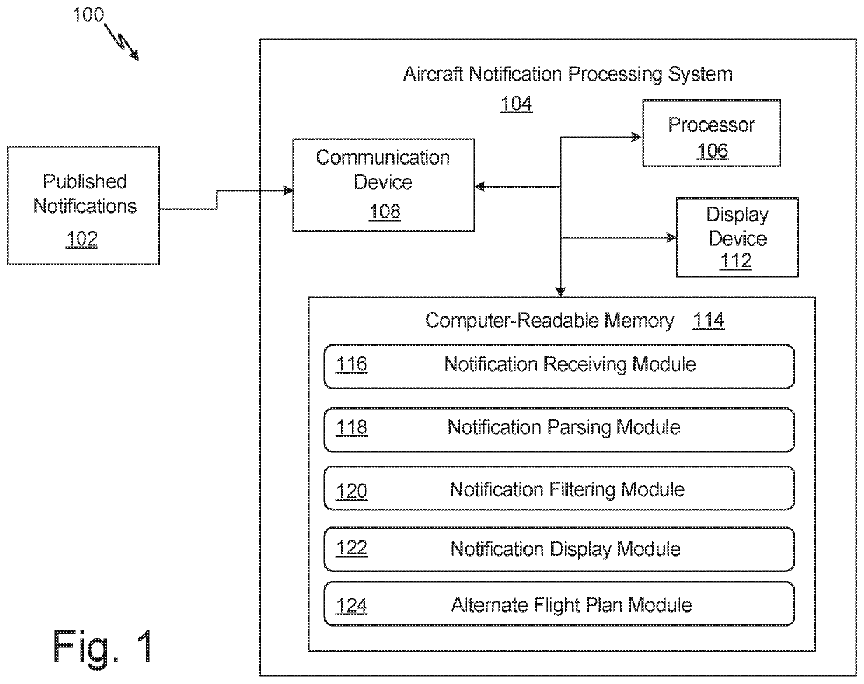

FIG. 1 is a schematic view of system 100 for filtering and presenting one or more notifications. System 100 includes published notifications 102 and aircraft notification processing system 104. Aircraft notification processing system 104 includes processor 106, communication device 108, display device 112, and computer-readable memory 114. Computer-readable memory 114 includes notification receiving module 116, notification parsing module 118, notification filtering module 120, notification display module 122, and alternate flight plan module 124.

Processor 106, in some examples, is configured to implement functionality and/or process instructions for execution within system 100. For instance, processor 106 can be capable of processing instructions stored in computer-readable memory 114. Examples of processor 106 can include any one or more of a microprocessor, a controller, a digital signal processor (DSP), an application specific integrated circuit (ASIC), a field-programmable gate array (FPGA), or other equivalent discrete or integrated logic circuitry.

Computer-readable memory 114, in some examples, is described as computer-readable storage media. In some examples, a computer-readable storage medium includes a non-transitory medium. The term “non-transitory” indicates that the storage medium is not embodied in a carrier wave or a propagated signal. In certain examples, a non-transitory storage medium stores data that, over time, changes (e.g., in RAM or cache). In some examples, computer-readable memory 114 is a temporary memory, meaning that a primary purpose of computer-readable memory 114 is not long-term storage. Computer-readable memory 114, in some examples, is described as volatile memory, meaning that computer-readable memory 114 does not maintain stored contents when electrical power to computer-readable memory 114 is removed. Examples of volatile memories can include random access memories (RAM), dynamic random access memories (DRAM), static random access memories (SRAM), and other forms of volatile memories. In some examples, computer-readable memory 114 is used to store program instructions for execution by processor 106. Computer-readable memory 114, in one example, is used by software or applications to temporarily store information during program execution. Computer-readable memory 114, in some examples, also includes one or more computer-readable storage media. Computer-readable memory 114 is configured to store larger amounts of information than volatile memory. Computer-readable memory 114 is further configured for long-term storage of information. In some examples, computer-readable memory 114 includes non-volatile storage elements. Examples of such non-volatile storage elements include, but are not limited to, magnetic hard discs, optical discs, flash memories, or forms of electrically programmable memories (EPROM) or electrically erasable and programmable (EEPROM) memories.

Display device 112 is an input and/or output device that enables a user to view the output of aircraft notification processing system 104. Display device 112 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users, machines, or other computing devices.

Published notifications 102 are operably connected to aircraft notification processing system 104 via an operable connection between published notifications 102 and communication device 108. Processor 106, communication device 108, and computer-readable memory 114 are interconnected within aircraft notification processing system 104.

Communication device 108 is an input and/or output device that allows aircraft notification processing system 104 to electronically receive data from published notifications 102, wherein published notifications 102 are a repository of notifications published, for example, by an aviation authority that are available for communication device to retrieve. In some embodiments, the notifications of published notifications 102 are transmitted to communication device 108 upon publishing. Communication device 108 can include a network interface card (NIC), a modem, a bridge, a hub, and/or a router, which may communicate with other network-attached components via wired and/or wireless connections.

In operation, computer-readable memory 114 is encoded with instructions that are executed by processor 106. Computer-readable memory 114 includes notification receiving module 116. Notification receiving module 116 includes one or more programs containing instructions to receive an input from published notification 102. Upon execution of notification receiving module 116, data (i.e., from published notifications 102) is received by processor 106.

The data received from published notifications 102 can be published NOTAMs, wherein the NOTAMs are published, for example, by an aviation authority such as the Federal Aviation Administration (FAA) and/or the International Civil Aviation Organization (ICAO). The published NOTAMs can contain information relevant to personnel concerned with flight operations (e.g., the flight crew). The NOTAMs of published notifications 102 can be indicative of a real-time abnormal status of a component of the NAS. For example, the NOTAMs of published notifications 102 can include information pertaining to a runway closure, restricted airspace, a taxi light out of service, or a lawn mowing or other maintenance event occurring on a given runway. As is apparent, the NOTAMs range from safety critical information to information that is merely informative. The preceding NOTAMs are examples, and it is understood that many other NOTAMs can be presented within published notifications 102.

Computer-readable memory 114 further includes notification parsing module 118. Notification parsing module 118 includes one or more programs containing instructions to parse the data received via execution of notification receiving module 118. Upon execution of notification parsing module 118, notifications are parsed via processor 106.

Notifications received via execution of notification receiving module 116 can be NOTAMs which are received in a standard abbreviation format. Thus, in one example, a NOTAM received by aircraft notification processing system 104 can read “!CID 11/014 CID NAV ILS RWY 9 OUT OF SERVICE 1511131230-1511131430”. The example NOTAM indicates that the ILS runway labeled runway 9 at CID airport is out of service on Nov. 13, 2015 from 12:30 UTC to 14:30 UTC. Upon executing notification parsing module 118, processor 106 can derive the indicated meaning from the example NOTAM and convert it into plain language and/or into a computer-readable format for further processing. The plain language output can be stored within computer-readable memory 114 such that, if necessary, it can be displayed to a user via display device 112 upon determining its relevance and criticality.

Any number of NOTAMs can be parsed by execution of notification parsing module 118. Further, it is understood that the techniques of this disclosure are not limited to the specific format of NOTAMs as published by various aviation authorities. Rather, the techniques of this disclosure can be applied to any notification system wherein an abbreviated or otherwise standardized notification can be converted to plain language and/or to a computer-readable format.

Computer-readable memory 114 further includes notification filtering module 120. Notification filtering module 120 includes one or more programs containing instructions to filter the notifications parsed via execution of notification parsing module 118. Upon execution of notification filtering module 120, notifications are filtered via processor 106 based upon one or more filtering criteria.

In some embodiments, the filtering of notifications is initially based on the applicability of a notification to the present flight plan of the aircraft using system 100. Thus, upon execution of notification filtering module 120, received notifications are evaluated with reference to the flight plan of the aircraft. Received notifications which are relevant to the flight plan are prioritized as compared to received notifications which are not relevant to the flight plan. In one example where the aircraft establishes a landing site of runway 9 and where the aircraft receives a notification that an ILS approach on runway 9 is closed, the received notification is deemed to be relevant. In another example where a notification indicates coordinates for restricted airspace, but the restricted airspace is not within or near the flight plan of the aircraft, the notification is deemed to be not relevant.

In some embodiments, the filtering of notifications is further based upon the criticality of the received notification. Notification filtering module 120 can be encoded with instructions which, when executed by processor 106, indicate the relative criticality of the received notifications. Critical information can be information that has a direct impact on safety, equipment damage, and/or regulatory violations. In the example above, in which the ILS approach on runway 9 is closed and wherein the aircraft establishes a landing site of runway 9, the received notification can be marked as a critical notification. In another example, a received notification may indicate that the taxi lights on runway 10 are out of service, while the aircraft has established a landing site of runway 10. In such an example, the notification can be marked as relevant but non-critical, as a landing is still allowed on runway 10, and the notification is merely intended to be informative.

In some embodiments, additional filtering can be done to curate a list of notifications based upon various filtering criteria. Filtering can be, for example, based upon time, altitude, GPS availability, runway length, fuel availability, weather reporting limitations, obstructions, and/or flight phase filters. This is not an exhaustive list, as there are many NOTAMS possible. Any NOTAM that would interfere with the flight plan, from receiving the flight plan, movement on the ground and in air should be considered. In some embodiments, such filtering criteria are indicated by the aircraft operator. Thus, for example, upon reaching the vicinity of a destination airport, a pilot can indicate that critical notifications should be filtered based upon a landing phase. In another example, where the aircraft is maintaining a constant altitude, the pilot can indicate that critical notifications should be filtered based upon the aircraft altitude (e.g., restricted airspace at the present altitude). The preceding examples are intended to be illustrative of the filtering capabilities and non-limiting.

Computer-readable memory 114 further includes notification display module 122. Notification display module 122 includes one or more programs containing instructions to display the notifications filtered via the execution of notification filtering module 120. Upon execution of notification display module 120, notifications are displayed via display device 112.

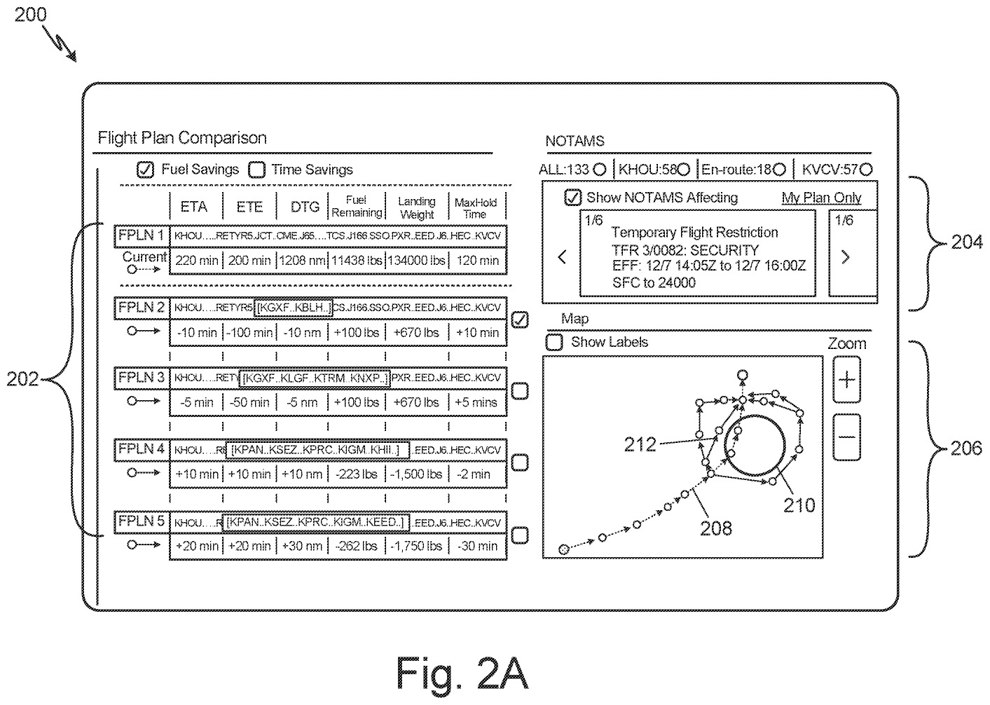

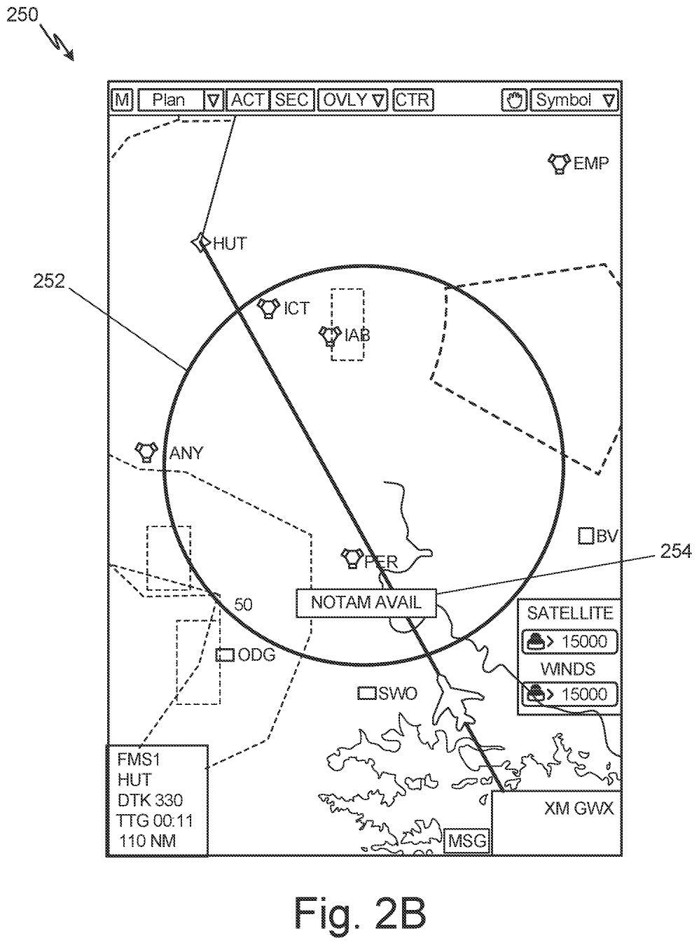

In some embodiments, the NOTAMs that are relevant to the flight plan are displayed as an overlay on a map shown on display device 122. Such an embodiment is described in greater detail in the description of FIG. 2A. Additionally, relevant NOTAMs can be displayed based on color coding, wherein the color of the display message corresponds to the criticality of the NOTAM. For example, a yellow notification can be indicative of a critical NOTAM which the flight crew must address, whereas a white or cyan notification can be indicative of a non-critical but relevant NOTAM. In some embodiments, critical NOTAMs are displayed and require an acknowledgement from the flight crew. The flight crew can then use a user interface within display device 122 to indicate that the NOTAM was acknowledged. In some embodiments, additional NOTAMs which are not relevant to the current flight plan, but were still received from published notifications 202, can also be available for viewing by the flight crew.

Computer-readable memory 114 further includes alternate flight plan module 124. Alternate flight plan module 124 includes one or more programs containing instructions to generate and display alternate flight plans in response to one or more of the relevant notifications restricting the present flight plan. Upon execution of alternate flight plan module 124, alternate flight plans are generated via processor 106 and displayed via display device 112. The term “flight plan” is used in a general sense to convey any planned or anticipated route to be taken by the aircraft from planning the flight, and executing the flight, from brake release, motion on the ground, through the air and parking brake application at the destination.

Upon execution of alternate flight plan module 124, processor 106 can determine whether NOTAMs exist which restrict the present flight plan. Where no such NOTAMs which restrict the present flight plan exist, no alternate flight plan is generated. Where such NOTAMs which restrict the present flight plan exist, an alternate flight plan can be generated and displayed. A NOTAM which restricts the present flight plan can, for example, include a NOTAM which indicates that the present flight plan passes through restricted airspace.

In some embodiments, the alternate flight plan is generated in real time by processor 106. In other embodiments, pre-defined flight plans are included within computer-readable memory 114, and are displayed upon determining that an alternate flight plan is necessary. In some embodiments, many alternate flight plans can be displayed which the aircraft operator can choose from. In some embodiments, the alternate flight plans are displayed on a map overlay via display device 112. If a map overlay is not available, the message and notification can be made via crew message and/or plain text.

In some embodiments, the encoded modules of computer-readable memory 114 are executed upon the alternate flight plan. Thus, notification receiving module 116, notification parsing module 118, notification filtering module 120, and notification filtering module 122 are executed based upon the alternate flight plan to determine salient NOTAMs that are applicable to the alternate flight plan. In some embodiments, the execution of the encoded modules is triggered when selecting an alternate flight plan. Additional description of the display of alternate flight plans is described in the description of FIG. 2A.

System 100 has several advantages. System 100 allows for the receiving, parsing, filtering, and displaying of notifications received by an aircraft. Through the filtering, relevant and critical notifications can be displayed. Thus, the aircraft crew does not have to parse through a plurality of received notifications manually, and potentially miss critical information. Rather, the critical information is presented to the aircraft crew. Further, the executable modules of computer-readable memory are repeatedly executed so as to continually monitor incoming notifications. Further, the information presented to the aircraft crew can be color coded, or otherwise distinguished, in order to show the criticality level. Thus, the aircraft crew can prioritize received notifications in order to address such received notifications in order of criticality. Additionally, system 100 is configured to output alternative flight plans in response to the notifications restricting the present flight plan. Again, this allows for the aircraft crew to change course in compliance with received notifications and reduces the potential of missed notifications that may cause the aircraft crew to fly in violation of regulations.

FIG. 2A is an example of pilot interface 200 for displaying alternate flight plans on display device 112 based upon the one or more notifications. Pilot interface 200 is an example output that is generated by the execution of alternate flight plan module 124 and displayed upon display device 112 of system 100. Pilot interface 200 includes alternate flight plan display 202, NOTAM messaging display 204, and map overlay 206. Map overlay 206 includes current flight path 208, restricted flight zone 210, and secondary flight path 212.

As described with respect to system 100, pilot interface 200 can be displayed upon processor 106 determining that an alternate flight plan is necessary due to one or more NOTAMs restricting a present flight plan. The one or more NOTAMs restricting the present flight plan can be displayed within NOTAM messaging display 204. In some embodiments, the NOTAMs displayed within NOTAM messaging display 204 are color coded based upon the criticality of the NOTAMs. In one example, the NOTAMs within NOTAM messaging display can have a high criticality level or a low criticality level, wherein the high criticality level is indicated by a yellow notification and a low criticality level is indicated by a white or cyan notification. In some embodiments, a NOTAM with high criticality is displayed as a warning message. It is understood that any number of criticality levels can be used and any color scheme or other method of differentiating the criticality levels is contemplated by this disclosure.

Alternate flight plan display 202 depicts available alternate flight plans which overcome the restrictions on the present flight plan. Alternate flight plan display 202 can include proposed alternate flight routes including indicators which can inform the aircraft operator as to the relevant parameter changes from the present flight plan to a potential alternative flight plan. The indicators can include an estimated time of arrival, a total flight time, a distance remaining, a measurement of fuel remaining, a landing weight, and a maximum hold time. This is not an exhaustive list; there are many such indicators that may be tailored to the end user. The disclosed indicators are intended as examples, and it is understood that other parameters can be considered, calculated, displayed, and used as indicators by the aircraft operator.

Further, with respect to alternate flight plan display 202, absolute values can be shown instead of the relative parameter changes depicted in FIG. 2A. For example, the landing weight for FPLN 2 can be shown as 134670 lbs. as an absolute value instead of the relative +670 lbs., which is currently depicted. In some embodiments, any combination of absolute and relative values can be displayed via alternate flight plan display 202. In some embodiments, a system operator can toggle between absolute and relative values.

Map overlay 206 depicts a visual of the current flight path 208, restricted flight zone 210, and secondary flight path 212. Restricted flight zone 210 displays the zone in which the temporary flight restriction (i.e., as indicated from the NOTAM within NOTAM messaging display 204) exists. Current flight path 208 depicts the current trajectory of the aircraft, which, in the depicted example, passes through restricted flight zone 210. Secondary flight path 212 depicts the flight path of FPLN 2, as shown within alternate flight plan display 202. In the depicted example, FPLN 2 avoids restricted flight zone 210.

In some embodiments, the alternate flight plans depicted on alternate flight plan display 202 can be generated in real time to avoid airspace to which the one or more applicable NOTAMs restricting the present flight plan apply. In other embodiments, the alternate flight plans are predetermined flight plans that are saved within, for example, computer-readable memory 114.

FIG. 2B is an example of pilot interface 250 for displaying one or more notifications as a map overlay. Pilot interface 250 includes restricted flight zone 252 and NOTAM 254. In the depicted example, NOTAM 254 is a received notification that results in restricted flight zone 252. In some embodiments, NOTAM 254 can be displayed whether restricted flight zone 252 is concurrently displayed or not. In one example, pilot interface 250 is displayed prior to pilot interface 200 (FIG. 2A), and interaction with NOTAM 254 within pilot interface 250 can result in the generation and display of pilot interface 200.

Pilot interface 200 and pilot interface 250 have several advantages. The map overlay of pilot interface 250 allows for the aircraft operator to know that a salient NOTAM has been generated and the geographical airspace that the salient NOTAM affects. Pilot interface 200 provides the advantage of detailing the NOTAM in plain language (i.e., converted from the standard abbreviation) as depicted within NOTAM messaging display 204. Further, pilot interface 200 provides the advantage of presenting one or more alternate flight plans with flight plan indicators in order to inform the aircraft operator of additional flight plan options and the resulting parameters therefrom. Thus, pilot interface 200 and pilot interface 250 allow for a pilot to be quickly informed about a salient NOTAM and to be able to choose an appropriate alternate flight plan in response to the salient NOTAM, based on a plurality of relevant information.

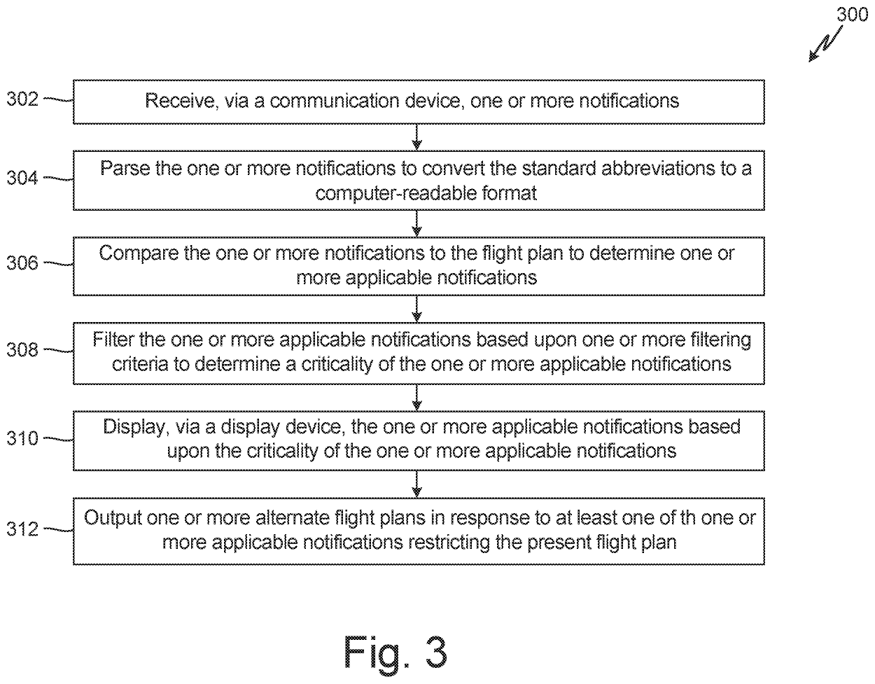

FIG. 3 is a flowchart depicting method 300 for filtering and presenting notifications. The description of method 300 will make reference to the component numbers of system 100 (FIG. 1) for clarity.

Method 300 begins at step 302, wherein aircraft notification processing system 104 receives one or more notifications from published notifications 102 via communication device 108. The one or more notifications can be one or more NOTAMs published by, for example, an aviation authority.

At step 304, processor 106 parses the one or more notifications to convert the one or more notifications from an abbreviation to a computer-readable and/or plain language format. NOTAMs published by aviation authorities can, for example, follow a standard abbreviation format, as described above. At step 306, processor 106 compares the one or more notifications to the present flight plan in order to determine one or more applicable notifications to the present flight plan. Notifications which are relevant to the flight plan are prioritized as compared to notifications which are not relevant to the flight plan.

At step 308, processor 106 filters the notifications based upon one or more filtering criteria to determine a criticality of the notifications. Critical information can be information that has a direct impact on safety, equipment damage, and/or regulatory violations. Additional filtering criteria can be based upon, for example, time, altitude, GPS availability, runway length, fuel availability, weather reporting limitations, obstructions, and/or flight phase filters.

At step 310, the one or more notifications are displayed via display device 112. The notifications can be displayed based upon criticality and the applicable filters wherein the critical notifications are highlighted. The notifications which are classified as non-critical can also be available for viewing by the aircraft crew.

At step 312, one or more alternate flight plans can be output and displayed via display device 112. The alternate flight plans can be generated in response to at least one of the received notifications restricting the present flight plan. The alternate flight plans can, in one example, be displayed as depicted in FIG. 2A.

The techniques of this disclosure allow for parsing and presenting notifications, and specifically NOTAMs, to an aircraft crew. By sorting NOTAMs based on relevance and filtering NOTAMs based upon criticality, the system notifies the aircraft crew of salient NOTAMs that are otherwise in danger of being missed by manual review by the aircraft crew. If an alternate flight plan is required based upon one or more of the NOTAMs (e.g., due to a runway closure), the system can propose alternate flight plans. Thus, the techniques of this disclosure allow for heightened safety and regulatory compliance by filtering and presentation of notifications.

### Discussion of Possible Embodiments

The following are non-exclusive descriptions of possible embodiments of the present invention.

A system for filtering and presenting notifications received by an aircraft includes a processor and a display device operably connected to the processor. The system further includes a communication device operably connected to the processor. The system further includes computer-readable memory operably connected to the processor, the computer-readable memory encoded with instructions that, when executed by the processor, cause the system to perform the following steps. The system receives, via the communication device, one or more broadcasted notifications. The system filters the one or more broadcasted notifications based upon applicability to a present flight plan to generate one or more applicable notifications. The system filters the one or more applicable notifications based upon one or more filtering criteria to assign a criticality to each of the one or more applicable notifications. The system display, via the display device, the one or more applicable notifications based upon the criticality of each of the one or more applicable notifications.

The system of the preceding paragraph can optionally include, additionally and/or alternatively, any one or more of the following features, configurations and/or additional components:

A further embodiment of the foregoing system, wherein the one or more broadcasted notifications are one or more published notifications published by an external aviation publisher.

A further embodiment of any of the foregoing systems, wherein the one or more broadcasted notifications are one or more Notices to Air Missions (NOTAMs).

A further embodiment of any of the foregoing systems, wherein the one or more NOTAMs are received in a standard abbreviated format and wherein the computer-readable memory is further encoded with instructions that, when executed by the processor, cause the system to parse the one or more NOTAMs to convert the standard abbreviated format to a computer-readable format and/or a plain language format.

A further embodiment of any of the foregoing systems, wherein the one or more applicable notifications are a subset of NOTAMs within the broadcasted notifications that are relevant to the present flight plan.

A further embodiment of any of the foregoing systems, wherein the computer-readable memory is further encoded with instructions that, when executed by the processor, cause the system to output one or more alternate flight plans in response to at least one of the one or more applicable notifications restricting the present flight plan.

A further embodiment of any of the foregoing systems, wherein the one or more alternate flight plans include any planned route to be taken by the aircraft including brake release, motion on the ground, air travel, and parking brake application at a destination.

A further embodiment of any of the foregoing systems, wherein the one or more alternate flight plans include indicators of an estimated time of arrival, a total flight time, a distance remaining, a measurement of fuel remaining, a landing weight, and a maximum hold time.

A further embodiment of any of the foregoing systems, wherein the one or more alternate flight plans are generated in real time to avoid airspace to which the one or more applicable notifications restricting the present flight plan apply.

A further embodiment of any of the foregoing systems, wherein the one or more alternate flight plans are displayed via the display device as a map overlay.

A further embodiment of any of the foregoing systems, wherein a restricted flight area is displayed via the display device as a map overlay based upon the at least one of the one or more applicable notifications restricting the present flight plan.

A further embodiment of any of the foregoing systems, wherein the one or more filtering criteria include filters based upon a present flight plan.

A further embodiment of any of the foregoing systems, wherein the one or more filtering criteria include time-based filter, altitude-based filters, GPS availability, runway length, fuel availability, weather reporting limitations, obstructions, and/or flight phase filters.

A further embodiment of any of the foregoing systems, wherein the one or more applicable notifications are displayed with an assigned color based upon the criticality of each of the one or more applicable notifications.

A further embodiment of any of the foregoing systems, wherein the one or more applicable notifications are displayed as an overlay on a map.

A method for filtering and presenting notifications received by an aircraft includes receiving via a communication device, one or more broadcasted notifications. The method further includes filtering the one or more broadcasted notifications based upon applicability to a present flight plan to generate one or more applicable notifications. The method further includes filtering the one or more applicable notifications based upon one or more filtering criteria to assign a criticality to each of the one or more applicable notifications. The method further includes displaying, via a display device, the one or more applicable notifications based upon the criticality of each of the one or more applicable notifications.

A further embodiment of the foregoing method, wherein the one or more broadcasted notifications are one or more Notices to Air Missions (NOTAMs).

A further embodiment of any of the foregoing methods, wherein the one or more NOTAMs are received in a standard abbreviated format and wherein the method further comprises: parsing the one or more NOTAMs to convert the standard abbreviated format to a computer-readable format and/or a plain language format.

A further embodiment of any of the foregoing methods, further including outputting one or more alternate flight plans in response to at least one of the one or more applicable notifications restricting the present flight plan.

A further embodiment of any of the foregoing methods, wherein the one or more alternate flight plans include indicators of an estimated time of arrival, a total flight time, a distance remaining, a measurement of fuel remaining, a landing weight, and a maximum hold time.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system for filtering and presenting notifications received by an aircraft, the system comprising:
a processor;
a display device operably connected to the processor;
a communication device operably connected to the processor; and
computer-readable memory operably connected to the processor, the computer-readable memory encoded with instructions that, when executed by the processor, cause the system to:
receive, via the communication device, one or more broadcasted notifications;
filter the one or more broadcasted notifications based upon applicability to a present flight plan to generate one or more applicable notifications;
filter the one or more applicable notifications based upon one or more filtering criteria to assign a criticality to each of the one or more applicable notifications; and
display, via the display device, the one or more applicable notifications based upon the criticality of each of the one or more applicable notifications.

2. The system of claim 1, wherein the one or more broadcasted notifications are one or more published notifications published by an external aviation publisher.

3. The system of claim 2, wherein the one or more broadcasted notifications are one or more Notices to Air Missions (NOTAMs).

4. The system of claim 3, wherein the one or more NOTAMs are received, via the communication device, in a standard abbreviated format and wherein the computer-readable memory is further encoded with instructions that, when executed by the processor, cause the system to parse the one or more NOTAMs to convert the standard abbreviated format to a computer-readable format and/or a plain language format.

5. The system of claim 3, wherein the one or more applicable notifications are a subset of NOTAMs within the broadcasted notifications that are relevant to the present flight plan.

6. The system of claim 1, wherein the computer-readable memory is further encoded with instructions that, when executed by the processor, cause the system to:
output one or more alternate flight plans in response to at least one of the one or more applicable notifications restricting the present flight plan.

7. The system of claim 6, wherein the one or more alternate flight plans include any planned route to be taken by the aircraft including brake release, motion on the ground, air travel, and parking brake application at a destination.

8. The system of claim 6, wherein the one or more alternate flight plans include indicators of an estimated time of arrival, a total flight time, a distance remaining, a measurement of fuel remaining, a landing weight, and a maximum hold time.

9. The system of claim 6, wherein the one or more alternate flight plans are generated in real time to avoid airspace to which the one or more applicable notifications restricting the present flight plan apply.

10. The system of claim 6, wherein the one or more alternate flight plans are displayed via the display device as a map overlay.

11. The system of claim 10, wherein a restricted flight area is displayed via the display device as a map overlay based upon the at least one of the one or more applicable notifications restricting the present flight plan.

12. The system of claim 1, wherein the one or more filtering criteria include filters based upon the present flight plan.

13. The system of claim 12, wherein the one or more filtering criteria include time-based filter, altitude-based filters, GPS availability, runway length, fuel availability, weather reporting limitations, obstructions, and/or flight phase filters.

14. The system of claim 1, wherein the one or more applicable notifications are displayed with an assigned color based upon the criticality of each of the one or more applicable notifications.

15. The system of claim 1, wherein the one or more applicable notifications are displayed as an overlay on a map.

16. A method for filtering and presenting notifications received by an aircraft, the method comprising:
receiving, via a communication device, one or more broadcasted notifications;
filtering the one or more broadcasted notifications based upon applicability to a present flight plan to generate one or more applicable notifications;
filtering the one or more applicable notifications based upon one or more filtering criteria to assign a criticality to each of the one or more applicable notifications; and
displaying, via a display device, the one or more applicable notifications based upon the criticality of each of the one or more applicable notifications.

17. The method of claim 15, wherein the one or more broadcasted notifications are one or more Notices to Air Missions (NOTAMs).

18. The method of claim 16, wherein the one or more NOTAMs are received in a standard abbreviated format and wherein the method further comprises: parsing the one or more NOTAMs to convert the standard abbreviated format to a computer-readable format and/or a plain language format.

19. The method of claim 15, further comprising:
outputting one or more alternate flight plans in response to at least one of the one or more applicable notifications restricting the present flight plan.

20. The method of claim 18, wherein the one or more alternate flight plans include indicators of an estimated time of arrival, a total flight time, a distance remaining, a measurement of fuel remaining, a landing weight, and a maximum hold time.
